(19) United States
(12) Patent Application Publication
(10) Pub. No.: US 2026/0274114 A1
(43) Pub. Date: Sep. 17, 2026

(54) CONTROLLER FOR VEHICLE

(71) Applicant: TOYOTA JIDOSHA KABUSHIKI KAISHA, Toyota-shi (JP)

(72) Inventor: Shun SATO, Toyota-shi (JP)

(73) Assignee: TOYOTA JIDOSHA KABUSHIKI KAISHA, Toyota-shi (JP)

(21) Appl. No.: 19/558,606

(22) Filed: Mar. 6, 2026

(30) Foreign Application Priority Data
Mar. 13, 2025 (JP) 2025-040124

(51) Int. Cl. B60L 58/27; B60L 58/15

(52) U.S. Cl. CPC B60L 58/27; B60L 58/15; B60L 2240/545; B60L 2240/547

(57) ABSTRACT

An execution device of a controller for a vehicle is configured to, when the heater is driven, execute predicting a temperature of a battery that is to occur at a preset time when the heater has been stopped at a determination time that is earlier than the preset time, calculating, based on the predicted temperature of the battery at the preset time, a maximum discharge amount of the battery applicable at the preset time, and stopping a heater at the determination time on condition that the calculated maximum discharge amount at the preset time is greater than or equal to a predetermined lower-limit discharge amount at which a delayed response at start-up of the vehicle falls within an allowable range.

### CROSS-REFERENCE TO RELATED APPLICATIONS

This application is based upon and claims the benefit of priority from Japanese Patent Application No. 2025-040124, filed on Mar. 13, 2025, the entire contents of which are incorporated herein by reference.

### BACKGROUND

### 1. Field

The present disclosure relates to a controller for a vehicle.

### 2. Description of Related Art

JP2018-102084A discloses a vehicle provided with a battery for driving a drive motor. The battery is configured to be charged by a power supply facility such that the state of charge at a preset time reaches a predetermined target state of charge.

In the vehicle described in the above publication, in a case where the temperature of the battery is excessively low when the vehicle is used after the charging by the power supply facility is finished, the maximum discharge amount of the battery is restricted. As a result, a delayed response may occur at start-up of the vehicle. In order to cope with this problem, the vehicle may be provided with a heater for raising the temperature of the battery.

The controller of the vehicle may drive the heater to prevent the temperature of the battery from becoming excessively low when the vehicle is started. In this case, the vehicle may consume excessive electric power because the heater continues to be driven.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A controller for a vehicle according to an aspect of the present disclosure is provided. The vehicle includes a battery configured to store electrical energy for driving a drive motor and a heater configured to heat the battery. The battery is configured to be charged by a power supply facility such that a state of charge at a preset time reaches a predetermined target state of charge. The controller comprises an execution device. The execution device is configured to, when the heater is driven, execute predicting a temperature of the battery that is to occur at the preset time, in a case where the heater has been stopped at a determination time earlier than the preset time, calculating, based on the predicted temperature of the battery at the preset time, a maximum discharge amount of the battery that is to occur at the preset time, and stopping the heater at the determination time on condition that the calculated maximum discharge amount at the preset time is greater than or equal to a predetermined lower-limit discharge amount at which a delayed response at start-up of the vehicle falls within an allowable range.

Other features and aspects will be apparent from the following detailed description, the drawings, and the claims.

### BRIEF DESCRIPTION OF THE DRAWINGS

FIG. 1 is a schematic diagram illustrating a charging system according to an embodiment.

FIG. 2 is a flowchart showing a series of processes related to heater control performed by the controller of the vehicle of FIG. 1.

FIG. 3 is a diagram illustrating a case where the controller for the vehicle shown in FIG. 1 calculates the maximum discharge amount that is to occur at the preset time.

FIG. 4 is a timing diagram illustrating a case where the controller for the vehicle of FIG. 1 stops the heater, where section (a) shows changes in the battery temperature, section (b) shows changes in the state of charge, section (c) shows changes in the maximum discharge amount, and section (d) shows changes in the state of the heater.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Embodiment

Hereinafter, an embodiment of a charging system will be described with reference to the drawings.

### Outline of Charging System

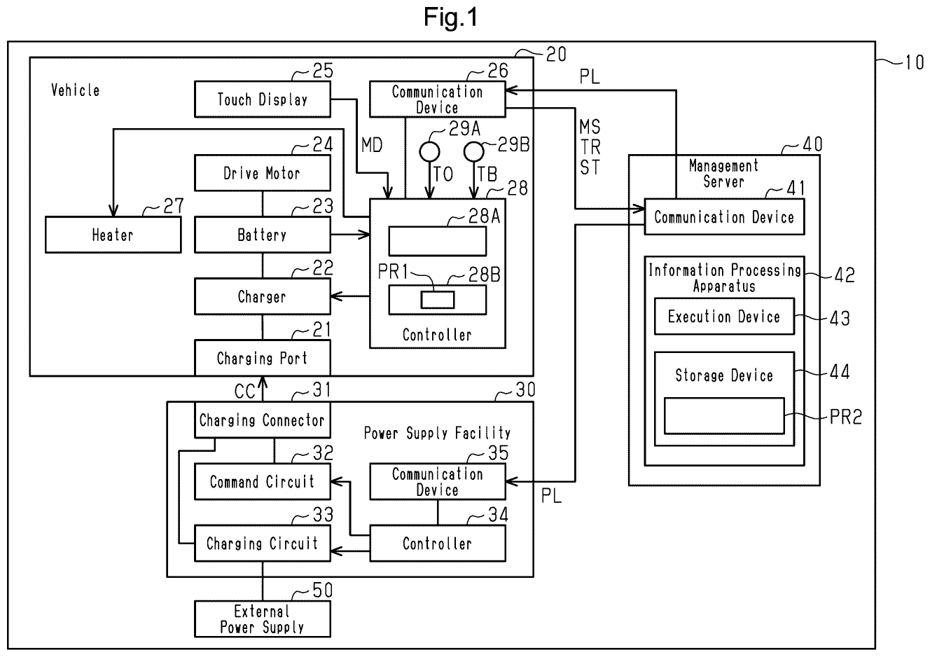

As shown in FIG. 1, a charging system 10 includes a vehicle 20, a power supply facility 30, a management server 40, and an external power supply 50. The charging system 10 manages charging of the vehicles 20 performed by the power supply facilities 30.

Each vehicle 20 includes a charging port 21, a charger 22, a battery 23, and a drive motor 24. The vehicle 20 is a battery electric vehicle. Each power supply facility 30 includes a charging connector 31 that is connectable to the corresponding charging port 21. Connecting the charging connector 31 to the charging port 21 allows the power supply facility 30 to charge the battery 23.

The drive motor 24 is a drive source for the vehicle 20. The drive motor 24 drives the vehicle 20 using electrical energy stored in the battery 23. The battery 23 stores electrical energy for operating the drive motor 24.

The charger 22 includes a relay that switches connection and disconnection of an electric power path between the charging port 21 and the battery 23, and a power conversion circuit. The battery 23 is charged by controlling the charger 22.

The vehicle 20 includes a touch display 25, a communication device 26, a heater 27, and a controller 28.

The touch display 25 displays an image representing, for example, map information. The touch display 25 receives an operation signal when a touch operation is performed by the user. In the present embodiment, the touch display 25 displays an image for selecting a planned charging mode. In the planned charging mode, the battery 23 is charged by a charging command CC from the power supply facility 30, the command being based on a charging plan PL generated by the management server 40. The charging plan PL is time-series data representing requested power indicating a requested charging amount per unit time in a predetermined period.

The touch display 25 displays an image for setting a target value of the charging plan PL so that a touch operation for providing information necessary for the management server 40 to generate the charging plan PL can be received. When the touch operation is performed, the touch display 25 receives a preset time ST, which is the next scheduled use time, and a target state of charge TR as the target values of the charging plan PL. When the touch display 25 receives the preset time ST and the target state of charge TR, the touch display 25 outputs the preset time ST and the target state of charge TR to the controller 28.

The touch display 25 displays an image for selecting a traveling mode MD of the vehicle 20. The traveling mode MD is selected from a first traveling mode and a second traveling mode. The first traveling mode is, for example, an eco-mode. The second traveling mode is, for example, a drive mode. The second traveling mode requires a larger amount of discharge from the battery 23 than the first traveling mode.

When a touch operation for selecting the first traveling mode is performed on the touch display 25, the touch display 25 transmits a signal indicating that the first traveling mode has been selected to the controller 28.

When a touch operation for selecting the second traveling mode is performed on the touch display 25, the touch display 25 transmits a signal indicating that the second traveling mode has been selected to the controller 28.

The heater 27 raises the temperature of the battery 23, for example, by being driven using electric power supplied from the battery 23. The heater 27 can be driven even when the charging connector 31 of the power supply facility 30 is connected to the charging port 21. The heater 27 is driven so that a battery temperature TB becomes a predetermined target temperature TT. The target temperature TT is determined in advance through testing or simulation as a temperature at which a maximum discharge amount DM of the battery 23 does not become excessively small. The target temperature TT is, for example, 0 degrees Celsius.

The vehicle 20 includes an outside-air temperature sensor 29A and a battery temperature sensor 29B. The outside-air temperature sensor 29A detects an outside-air temperature TO in the vehicle 20. The outside-air temperature sensor 29A outputs the detected outside-air temperature TO to the controller 28. The battery temperature sensor 29B detects a battery temperature TB, which is the temperature of the battery 23. The battery temperature sensor 29B outputs the detected battery temperature TB to the controller 28.

The controller 28 performs various types of control on the vehicle 20 as a control target. The controller 28 controls the charger 22 to charge the battery 23. Upon detecting that the charging connector 31 has been connected to the charging port 21, the controller 28 controls the charger 22 to start charging the battery 23. The controller 28 refers to the state of charge SOC of the battery 23, and controls the charger 22 to end the charging of the battery 23 in accordance with the state of charge SOC.

The controller 28 controls the communication device 26 so as to transmit various signals from the communication device 26 to the management server 40. The controller 28 acquires the outside-air temperature TO from the outside-air temperature sensor 29A. The controller 28 acquires the battery temperature TB from the battery temperature sensor 29B.

The controller 28 controls driving and stopping of the heater 27. The controller 28 includes an execution device 28A and a storage device 28B. The execution device 28A is a central processing unit (CPU). That is, the execution device 28A is processing circuitry. The storage device 28B is a memory. The storage device 28B stores a heater control program PR1. The heater control program PR1 is executed by the execution device 28A to control the heater 27 when the power supply of the vehicle 20 is off. Details of the processing performed by the heater control program PR1 will be described later.

The communication device 26 is configured to communicate with the management server 40 via a wireless communication line. When the communication device 26 receives an operation signal indicating that the charging mode has been set to the planned charging mode from the controller 28, the communication device 26 transmits a setting notification MS to the management server 40. When the communication device 26 receives the preset time ST and the target state of charge TR from the controller 28, the communication device 26 transmits the preset time ST and the target state of charge TR to the management server 40. The communication device 26 receives information indicating the charging plan PL from the management server 40.

The management server 40 includes a communication device 41 and an information processing apparatus 42. The communication device 41 is configured to communicate with the vehicle 20 and the power supply facility 30 via a wireless communication line. The communication device 41 receives a setting notification MS from the vehicle 20. The communication device 41 receives a signal indicating the preset time ST and a signal indicating the target state of charge TR from the vehicle 20. The communication device 41 transmits the charging plan PL to the power supply facility 30 and the vehicle 20.

The information processing apparatus 42 includes an execution device 43 and a storage device 44. The execution device 43 is a CPU including a processor. The storage device 44 is a memory. The storage device 44 stores a generation program PR2.

When the execution device 43 executes the generation program PR2, the execution device 43 generates the charging plan PL based on the preset time ST and the target state of charge TR. Specifically, the execution device 43 calculates a start time TS at which charging is to be started when the battery 23 is charged with a predetermined charge amount per unit time such that the state of charge SOC becomes the target state of charge TR at the preset time ST. For example, the start time TS is calculated as a time three hours before the preset time ST. The execution device 43 generates a charging plan PL for charging the battery 23 with a predetermined amount of charge per unit time from the start time TS to the preset time ST. The execution device 43 may generate the charging plan PL in which the charging amount per unit time varies depending on the time period, for example, on the basis of the power rate that varies depending on the time period.

When the communication device 41 receives the setting notification MS, the execution device 43 starts execution of the generation program PR2. Thus, the information processing apparatus 42 generates the charging plan PL. The information processing apparatus 42 transmits a signal indicating generated charging plan PL to power supply facility 30.

The power supply facility 30 supplies electric power from the external power supply 50 to the corresponding vehicle 20 to charge the battery 23 of the vehicle 20. The power supply facility 30 is electric vehicle supply equipment (EVSE). The power supply facility 30 includes the charging connector 31, a command circuit 32, a charging circuit 33, a controller 34, and a communication device 35.

Each charging connector 31 is connectable to the charging port 21 of the corresponding vehicle 20. The charging connector 31 is connected to the command circuit 32 by a cable. The charging connector 31 is connected to the external power supply 50 via the charging circuit 33 by a cable. The external power supply 50 is located outside the vehicle 20. Connecting the charging connector 31 to the charging port 21 allows the power supply facility 30 to supply electric power from the external power supply 50 to the battery 23 via the charging circuit 33.

The command circuit 32 sends a charging command CC to the vehicle 20. Charging the charging connector 31 to the charging port 21 allows the command circuit 32 to send a charging command CC to the vehicle 20.

The charging circuit 33 charges the battery 23 from the external power supply 50. Connecting the charging connector 31 to the charging port 21 allows the charging circuit 33 to supply electric power from the external power supply 50 to the battery 23.

The communication device 35 is configured to communicate with the management server 40 via a wireless communication line. The communication device 35 receives information indicating the charging plan PL from the management server 40.

When receiving the charging plan PL from the management server 40, the controller 34 controls the command circuit 32 and the charging circuit 33 so as to perform charging in the planned charging mode. In the planned charging mode, the controller 34 controls the supply of power from the external power supply 50 to the battery 23 in accordance with the charging plan PL acquired from the management server 40 via the communication device 35.

### Series of Processes for Heater Control

When the power of the vehicle 20 is turned off, the execution device 28A starts execution of the heater control program PR1. In the present embodiment, a determination time, which will be described later, is a time at which the process of step S15 is performed in a case where an affirmative determination is made in the processes of step S18 and S19 in a series of processes. Since the times at which the processes of step S12 to step S19 are performed are substantially the same time, the description will be made assuming that the times are the same current time.

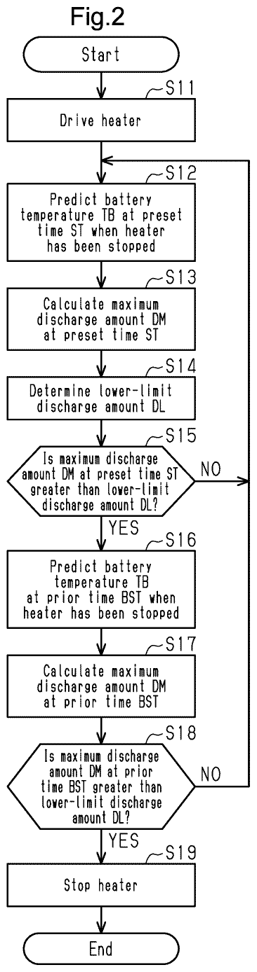

As shown in FIG. 2, upon starting execution of the heater control program PR1, the execution device 28A first executes the process of step S11. In step S11, the execution device 28A starts driving the heater 27. Accordingly, the heater 27 is driven to heat the battery 23. Then, the execution device 28A proceeds to step S12.

In step S12, the execution device 28A predicts the battery temperature TB that is to occur at the preset time ST, in a case where the heater 27 has been stopped at the determination time. For example, the execution device 28A first acquires the battery temperature TB obtained at the current time, at which the process of step S12 is performed, and the outside-air temperature TO obtained at the current time.

Next, using a predetermined outside-air temperature prediction map, the execution device 28A predicts the outside-air temperature TO that is to occur at the preset time ST based on the outside-air temperature TO obtained at the current time. The outside-air temperature prediction map is, for example, a function that represents temperature changes over the course of a day. In response to inputs of the current time, the outside-air temperature TO at the current time, and the preset time ST, the outside-air temperature prediction map outputs the outside-air temperature TO that is to occur at the preset time ST, the temperature resulting from a change from the outside-air temperature TO at the current time as time elapses from the current time to the preset time ST. Thus, the execution device 28A predicts the outside-air temperature TO that is to occur at the preset time ST.

Subsequently, the execution device 28A calculates the duration from the current time to the preset time ST. Using a battery temperature prediction map stored in the storage device 28B, the execution device 28A predicts the battery temperature TB that is to occur at the preset time ST, based on the battery temperature TB at the current time, the outside-air temperature TO at the preset time ST, and the duration from the current time to the preset time ST.

In the battery temperature prediction map, the battery temperature TB at the preset time ST is predicted to be higher as the battery temperature TB at the current time increases. In the battery temperature prediction map, the battery temperature TB at the preset time ST is predicted to be higher as the outside-air temperature TO at the preset time ST increases. In the battery temperature prediction map, the battery temperature TB at the preset time ST is predicted to be closer to the outside-air temperature TO at the preset time ST as the duration from the current time to the preset time ST increases. After the execution device 28A predicts the battery temperature TB that is to occur at the preset time ST, the execution device 28A proceeds to step S13.

In step S13, the execution device 28A calculates the maximum discharge amount DM applicable at the preset time ST. For example, using a maximum discharge amount calculation map stored in the storage device 28B, the execution device 28A calculates the maximum discharge amount DM applicable at the preset time ST based on the predicted battery temperature TB at the preset time ST and the target state of charge TR.

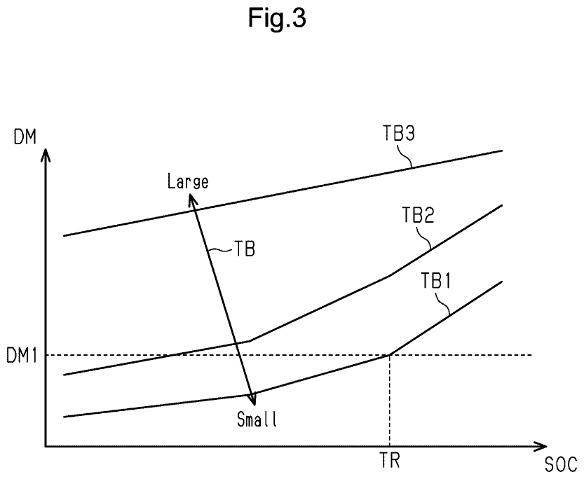

As shown in FIG. 3, the storage device 28B stores the maximum discharge amount calculation map including a function that indicates a relationship between the state of charge SOC and the maximum discharge amount DM, the relationship depending on the battery temperature TB. For example, the maximum discharge amount calculation map includes a function at the temperature TB1, a function at the temperature TB2, and a function at the temperature TB3. First, in step S13, when the battery temperature TB at the preset time ST is predicted to be the temperature TB1, the execution device 28A selects the function in which the battery temperature TB is the temperature TB1. Next, the execution device 28A inputs the target state of charge TR into the function in which the battery temperature TB is the temperature TB1. Then, the execution device 28A calculates a discharge amount DM1, which is the maximum discharge amount DM when the state of charge SOC of the battery 23 at the temperature TB1 is the target state of charge TR.

As shown in FIG. 2, after calculating the maximum discharge amount DM applicable at the preset time ST, the execution device 28A proceeds to step S14.

In step S14, the execution device 28A determines a lower-limit discharge amount DL. The lower-limit discharge amount DL is predetermined through testing or simulation as a lower-limit discharge amount at which a delayed response at start-up of the vehicle 20 falls within an allowable range. The storage device 28B stores the lower-limit discharge amount DL for each of the traveling modes MD of the vehicle 20. Specifically, the storage device 28B stores the lower-limit discharge amount DL in the first traveling mode and the lower-limit discharge amount DL in the second traveling mode. The lower-limit discharge amount DL in the second traveling mode is larger than the lower-limit discharge amount DL in the first traveling mode.

In step S14, the execution device 28A first specifies the traveling mode of the vehicle 20. Next, when the specified traveling mode of the vehicle 20 is the first traveling mode, the execution device 28A determines the lower-limit discharge amount DL in the first traveling mode as the lower-limit discharge amount DL. When the specified traveling mode of the vehicle 20 is the second traveling mode, the execution device 28A determines the lower-limit discharge amount DL in the second traveling mode as the lower-limit discharge amount DL. Then, the execution device 28A proceeds to step S15.

In step S15, the execution device 28A determines whether the maximum discharge amount DM at the preset time ST is greater than or equal to the lower-limit discharge amount DL. Specifically, the execution device 28A determines whether the maximum discharge amount DM at the preset time ST predicted in the process of step S12 is greater than or equal to the lower-limit discharge amount DL determined in the process of step S13.

When the maximum discharge amount DM at the preset time ST is less than the lower-limit discharge amount DL (S15: NO), the execution device 28A returns to step S12. When the maximum discharge amount DM at the preset time ST is greater than or equal to the lower-limit discharge amount DL (S15: YES), the execution device 28A proceeds to step S16.

In step S16, the execution device 28A predicts the battery temperature TB that is to occur at a prior time BST. The prior time BST is earlier than the preset time ST by a specified duration that has been determined in advance. The specified duration is predetermined through testing or simulation as a duration in which the vehicle 20 can be started by a user earlier than the preset time ST in a case where the user of the vehicle 20 has set the preset time ST. The specified duration is, for example, 10 minutes.

In step S16, the execution device 28A predicts the battery temperature TB that is to occur at the prior time BST in a case where the heater 27 has been stopped. For example, the execution device 28A first acquires the battery temperature TB obtained at the current time, at which the process of step S16 is performed, and the outside-air temperature TO obtained at the current time. Next, using the outside-air temperature prediction map, the execution device 28A predicts the outside-air temperature TO that is to occur at the prior time BST based on the outside-air temperature TO obtained at the current time. Then, the execution device 28A calculates the duration from the current time to the prior time BST. Using the battery temperature prediction map, the execution device 28A predicts the battery temperature TB that is to occur at the prior time BST, based on the battery temperature TB at the current time, the outside-air temperature TO at the prior time BST, and the duration from the current time to the prior time BST.

In the battery temperature prediction map, the battery temperature TB at the prior time BST is predicted to be higher as the battery temperature TB at the current time increases. In the battery temperature prediction map, the battery temperature TB at the prior time BST is predicted to be higher as the outside-air temperature TO at the prior time BST increases. In the battery temperature prediction map, the battery temperature TB at the prior time BST is predicted to be closer to the outside-air temperature TO at the prior time BST as the duration from the current time to the prior time BST increases. After the execution device 28A predicts the battery temperature TB that is to occur at the prior time BST, the execution device 28A proceeds to step S17.

In step S17, the execution device 28A calculates the maximum discharge amount DM applicable at the prior time BST. For example, first, the execution device 28A acquires the charging plan PL. Next, based on the acquired charging plan PL, the execution device 28A predicts the state of charge SOC that is to occur at the prior time BST. Then, using the maximum discharge amount calculation map, the execution device 28A calculates the maximum discharge amount DM applicable at the prior time BST, based on the predicted state of charge SOC at the prior time BST and the battery temperature TB at the prior time BST. Subsequently, the execution device 28A proceeds to step S18.

In step S18, the execution device 28A determines whether the maximum discharge amount DM at the prior time BST is greater than or equal to the lower-limit discharge amount DL. When the maximum discharge amount DM at the prior time BST is less than the lower-limit discharge amount DL (S18: NO), the execution device 28A returns to step S12 without stopping the heater 27.

When the maximum discharge amount DM at the prior time BST is greater than or equal to the lower-limit discharge amount DL (S18: YES), the execution device 28A proceeds to step S19. In step S19, the execution device 28A stops the heater 27. Then, the execution device 28A ends the current series of processes.

The execution device 28A suspends execution of the heater control program PRI when the power supply of the vehicle 20 is turned on or when the current time has passed the prior time BST. In this case, when the power supply of the vehicle 20 is turned on, the execution device 28A stops the heater 27.

### Operation of the Present Embodiment

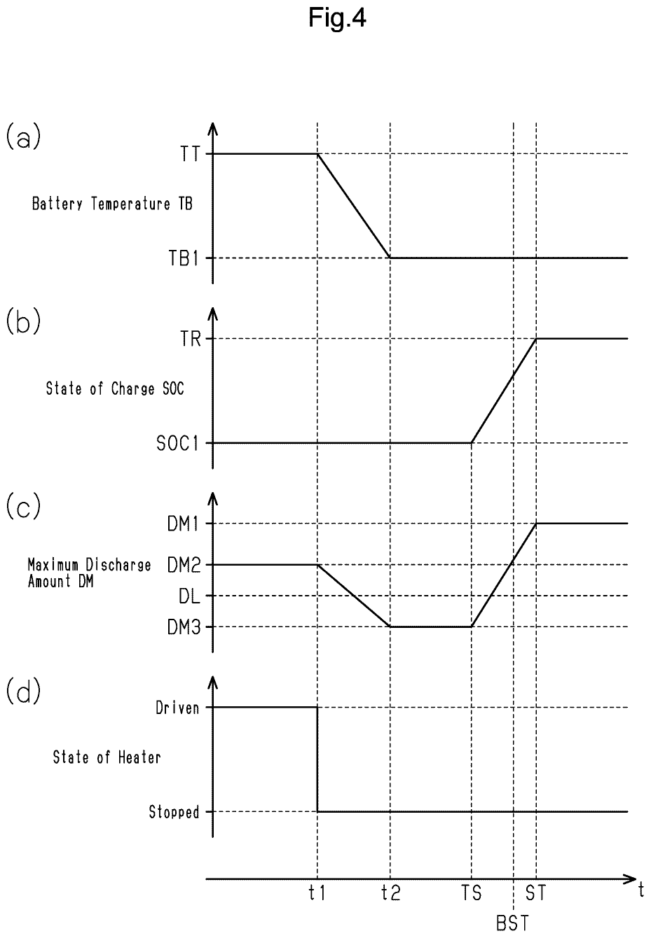

The operation of the present embodiment will now be described with reference to FIG. 4.

As illustrated in section (d) of FIG. 4, in the present embodiment, at time t1, the execution device 28A makes an affirmative determination in step S15 and step S18, and performs the process of step S19. That is, at time t1, the heater 27 is stopped.

As shown in section (a) of FIG. 4, when the heater 27 is stopped, the battery temperature TB, which has been maintained at the target temperature TT by the heater 27 until time t1, decreases from time t1. At times after time t2, the battery temperature TB becomes a temperature TB1, which is equal to the outside-air temperature TO and is lower than the target temperature TT.

As shown in section (c) of FIG. 4, as the battery temperature TB decreases, the maximum discharge amount DM, which is the discharge amount DM2 at time t1, decreases from time t1. At time t2, the maximum discharge amount DM becomes a discharge amount DM2 smaller than a discharge amount DM3. In the present embodiment, the discharge amount DM3 is less than the lower-limit discharge amount DL. The discharge amount DM2 is greater than or equal to the lower-limit discharge amount DL.

As shown in section (b) of FIG. 4, the charging of the battery 23 is started at the start time TS after time t2 in accordance with the charging plan PL. Thus, the state of charge SOC increases from the first state of charge SOC1 at the start time TS. At the preset time ST, which is after the start time TS, the state of charge SOC becomes the target state of charge TR.

As shown in section (c) of FIG. 4, as the state of charge SOC increases, the maximum discharge amount DM, which was the discharge amount DM3 at the start time TS, increases from the start time TS. At the prior time BST, which is after the start time TS, the maximum discharge amount DM becomes the discharge amount DM2. At the preset time ST, which is after the prior time BST, the maximum discharge amount DM becomes the discharge amount DM1.

### Advantages of the Present Embodiment

(1) Even when the vehicle 20 is started at the preset time ST, the maximum discharge amount DM is the discharge amount DM1, which is greater than or equal to the lower-limit discharge amount DL. This allows the controller 28 to limit the occurrence of an unallowable delayed response at start-up of the vehicle 20. The controller 28 stops the heater 27 after time t1 while limiting the occurrence of an unallowable delayed response at start-up of the vehicle 20. Thus, the amount of power consumption of the heater 27 is limited as compared to a case where the heater 27 is driven even after time t1. That is, the controller 28 limits excessive power consumption due to the heater 27 continuing to be driven.
(2) The maximum discharge amount DM of the battery 23 varies depending on the state of charge SOC. In this regard, the execution device 28A calculates the maximum discharge amount DM at the preset time based on the target state of charge TR. This allows the execution device 28A to more accurately calculate the maximum discharge amount DM at the preset time.
(3) The execution device 28A calculates the maximum discharge amount DM at the prior time BST based on the charging plan PL. The execution device 28A stops the heater 27 on an additional condition that the maximum discharge amount DM at the prior time BST is greater than or equal to the lower-limit discharge amount DL. Accordingly, even at the prior time BST, the maximum discharge amount DM becomes greater than or equal to the lower-limit discharge amount DL. Thus, when the vehicle 20 is started at a time earlier than the preset time ST and after the prior time BST, it is possible to limit the occurrence of an unallowable delayed response.
(4) The execution device 28A selects the lower-limit discharge amount DL in accordance with the acquired traveling mode, and determines whether the maximum discharge amount DM is greater than or equal to the lower-limit discharge amount DL at the preset time. Thus, even when the maximum discharge amount DM for limiting an unallowable delayed response changes depending on the traveling mode MD of the vehicle 20, the controller 28 limits the occurrence of an unallowable delayed response at start-up of the vehicle 20.

### Modifications

The above embodiment may be modified as follows. The above embodiment and the following modifications can be combined as long as the combined modifications remain technically consistent with each other.

The execution device 28A does not have to calculate the maximum discharge amount DM that is to occur at the preset time based on the target state of charge TR. For example, the execution device 28A may calculate the maximum discharge amount DM that is to occur at the preset time based on the time-series data representing the state of charge SOC charged by the charging plan PL.

The execution device 28A does not have to include, in the condition for stopping the heater 27, the condition that the maximum discharge amount DM at the prior time BST is greater than or equal to the lower-limit discharge amount DL. In this case, the execution device 28A does not have to acquire the charging plan PL, and the execution device 28A may omit the processes of steps S16 to S18.

The traveling mode MD of the vehicle 20 does not have to include the first traveling mode and the second traveling mode. The execution device 28A may use the same lower-limit discharge amount DL regardless of the traveling mode.

The execution device 28A does not have to start driving the heater 27 when the power supply of the vehicle 20 is turned off. For example, the execution device 28A may drive the heater 27 when the battery temperature TB becomes lower than a predetermined temperature.

The execution device 28A does not have to repeatedly perform the processes of steps S12 to S18. For example, the determination time may be set to a time earlier than the preset time ST by a predetermined duration. In this case, the execution device 28A may perform the processing from step S12 to step S18 only once in one charging plan PL. In this case, when a negative determination is made in the process of step S15, the execution device 28A may end the series of processes. In this case, when a negative determination is made in the process of step S18, the execution device 28A may end the series of processes.

In the above embodiment, the controller 28 is provided with the execution device 28A, which is processing circuitry including one or more processors that run computer programs (software) to execute various processes. However, the controller 28 may be provided with processing circuitry including one or more dedicated hardware circuits, such as application-specific integrated circuits (ASICs) that execute at least some of the processes. Alternatively, the controller 28 may be provided with processing circuitry including a combination of one or more processors and one or more dedicated hardware circuits. The processor includes a CPU and a memory, such as a RAM and a ROM. The memory stores program codes or instructions configured to cause the CPU to execute the processes. The memory, or a computer-readable medium, includes any type of medium that is accessible by general-purpose computers and dedicated computers. The same applies to the information processing apparatus 42 and the controller 34.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A controller for a vehicle, wherein
the vehicle includes a battery configured to store electrical energy for driving a drive motor and a heater configured to heat the battery,
the battery is configured to be charged by a power supply facility such that a state of charge at a preset time reaches a predetermined target state of charge,
the controller comprises an execution device, and
the execution device is configured to, when the heater is driven, execute:
predicting a temperature of the battery that is to occur at the preset time, in a case where the heater has been stopped at a determination time earlier than the preset time;
calculating, based on the predicted temperature of the battery at the preset time, a maximum discharge amount of the battery applicable at the preset time; and
stopping the heater at the determination time on condition that the calculated maximum discharge amount at the preset time is greater than or equal to a predetermined lower-limit discharge amount at which a delayed response at start-up of the vehicle falls within an allowable range.

2. The controller for the vehicle according to claim 1, wherein
the execution device is configured to calculate, when calculating the maximum discharge amount, the maximum discharge amount further based on the target state of charge.

3. The controller for the vehicle according to claim 1, wherein
the execution device is further configured to:
acquire a charging plan representing time-series data of a charging amount per unit time for setting, at the preset time, the state of charge to the target state of charge; and
calculate, based on the acquired charging plan, the maximum discharge amount applicable at a prior time that is earlier than the preset time by a predetermined duration, and
the execution device is configured to stop the heater at the determination time on an additional condition that the calculated maximum discharge amount at the prior time is greater than or equal to the lower-limit discharge amount.

4. The controller for the vehicle according to claim 1, wherein
a traveling mode of the vehicle is selected from a first traveling mode and a second traveling mode that requires a larger amount of discharge from the battery than the first traveling mode,
the lower-limit discharge amount in a case where the second traveling mode is selected is greater than the lower-limit discharge amount in a case where the first traveling mode is selected, and
the execution device is further configured to:
acquire information indicating the traveling mode; and
select the lower-limit discharge amount corresponding to the acquired traveling mode to determine whether the maximum discharge amount at the preset time is greater than or equal to the selected lower-limit discharge amount.
